(19) United States
(12) Patent Application Publication
(10) Pub. No.: US 2020/0150443 A1
(43) Pub. Date: May 14, 2020

(54) PUPIL STEERING: COMBINER ACTUATION SYSTEMS

(71) Applicant: Facebook Technologies, LLC, Menlo Park, CA (US)

(72) Inventor: Ryan Michael Ebert, Issaquah, WA (US)

(21) Appl. No.: 16/584,191

(22) Filed: Sep. 26, 2019

Related U.S. Application Data
(60) Provisional application No. 62/760,410, filed on Nov. 13, 2018.

(51) Int. Cl. G02B 27/01

(52) U.S. Cl. CPC G02B 27/0179; G02B 27/0172; G02B 2027/0178; G02B 2027/0187; G02B 2027/0159; G02B 27/0176

(57) ABSTRACT

The disclosed computer-implemented method may include receiving control inputs at a controller. The controller may be part of an optical subassembly that is connected to a combiner lens via a connecting member. The method may also include determining a current position of the combiner lens relative to a frame. The combiner lens may be at least partially transmissive to visible light, and may be configured to direct image data provided by the optical subassembly to a user's eye. The method may further include actuating an actuator that may move the optical subassembly and connected combiner lens according to the received control inputs. The actuator may move the optical subassembly and connected combiner lens independently of the frame. Various other methods, systems, and computer-readable media are also disclosed.

### CROSS REFERENCE TO RELATED APPLICATION

This application claims the benefit of U.S. Provisional Application No. 62/760,410, filed 13 Nov. 2019, the disclosure of which is incorporated, in its entirety, by this reference.

### BACKGROUND

Virtual reality (VR) and augmented reality (AR) systems display images to a user in an attempt to create virtual or modified worlds. Such systems typically have some type of eyewear such as goggles or glasses. These goggles and glasses project images onto the user's eyes according to image input signals. The user then sees either an entirely virtual world (i.e., in VR), or sees his or her real-world surroundings, augmented by additional images (i.e., in AR).

These augmented reality systems, however, may not work properly if the pupil of the AR display is not steered onto the user's eye. Traditional augmented reality displays typically project an image onto a screen in such a manner that the projected image has a very small exit pupil. As such, if the user looks sufficiently off of a nominal optical axis, the user may not be able to see any image at all.

### SUMMARY

As will be described in greater detail below, the instant disclosure describes systems and methods for tracking a user's eye movement and moving an optical projector system and combiner lens along with the user's eye movements. By moving such an optical projector system and combiner lens along with the user's eye movements, the system can provide a more stable image that responds to the user's eye movements and projects images where the user expects to see them. In this manner, the systems and methods herein may properly track a user's eye movements, ensuring that the user sees the images projected by the optical projector system.

In one embodiment, a system is provided for tracking a user's eye movements and moving an optical projector system and combiner lens along with the user's eye movements. The system may include the following: a frame, a connecting member, an optical subassembly attached to the frame that provides image data to a user's eye, and a combiner lens connected to the optical subassembly via the connecting member. The combiner lens may be at least partially transmissive to visible light, and may be configured to direct image data provided by the optical subassembly to the user's eye. The system may also include an actuator that moves the optical subassembly and connected combiner lens according to a control input. The actuator may move the optical subassembly and connected combiner lens independently of the frame.

In some examples, the actuator may be a piezoelectric bimorph. In other cases, the actuator may be a piezoelectric bender, a walking piezoelectric actuator, a piezoelectric inertia actuator, a mechanically-amplified piezo block actuator, a voice coil actuator, a DC motor, a brushless DC motor, a stepper motor, a microfluidic actuator, a resonance-based actuator, or other type of actuator. In some examples, the optical subassembly of the system may include a laser, a waveguide, a spatial light modulator and/or a combiner. The optical subassembly may include various electronic components configured to track movement of the user's eye. These eye-tracking electronic components may provide the control input used by the system. In such examples, the actuator may move the optical subassembly based on the user's eye movements.

In some examples, the connecting member may include a housing for the optical subassembly. In some examples, the system may include two optical subassemblies and two combiner lenses. In such cases, each combiner lens and connected optical subassembly may be actuated independently. Each combiner lens and connected optical subassembly may also be configured to track a separate user eye.

In some examples, the frame may include two arms. Each arm may include four actuators that move the optical subassembly and connected combiner lens. In such cases, two of the actuators may move the optical subassembly and connected combiner lens in the y direction, and two of the actuators may move the optical subassembly and connected combiner lens in the x direction, relative to the frame.

In some examples, the frame may include two arms. Each arm may include one or more bimorph actuators that move the optical subassembly and connected combiner lens. In such cases, one of the bimorph actuators may move the optical subassembly and connected combiner lens in the y direction, and one of the bimorph actuators may move the optical subassembly and connected combiner lens in the x direction, relative to the frame.

In one example, a computer-implemented method is provided for tracking a user's eye movement and moving an optical projector system and combiner lens along with the user's eye movements. The method may include receiving control inputs at a controller. The controller may be part of an optical subassembly that may be connected to a combiner lens via a connecting member. The method may also include determining a current position of the combiner lens relative to a frame. The combiner lens may be at least partially transmissive to visible light, and may be configured to direct image data provided by the optical subassembly to a user's eye. The method may further include actuating an actuator that may move the optical subassembly and connected combiner lens according to the received control inputs. The actuator may move the optical subassembly and connected combiner lens independently of the frame.

In some examples, the control inputs may be generated based on tracked eye movements of the user's eye.

In some examples, the frame may include a slot for the combiner lens to slide through as the combiner lens and connected optical subassembly are moved by the actuator. The combiner lens may be designed to slide substantially within the frame.

In some examples, piezoelectric strain amplifiers may be implemented to amplify movement of the optical subassembly and connected combiner lens. In such cases, the piezoelectric strain amplifiers may amplify movement of the optical subassembly and connected combiner lens by increasing the effective displacement of the bimorph actuators or other types of actuators.

In some examples, one or more displacement sensors may be affixed to the connecting member and may be implemented to determine movement of the optical subassembly and connected combiner lens.

In some examples, the optical subassembly may include a liquid crystal on silicon (LCOS) spatial light modulator.

In some examples, the above-described method may be encoded as computer-readable instructions on a computer-readable medium. For example, a computer-readable medium may include one or more computer-executable instructions that, when executed by at least one processor of a computing device, may cause the computing device to track a user's eye movement and move an optical projector system and combiner lens along with the user's eye movements. The computing device may receive control inputs at a controller. The controller may be part of an optical subassembly that may be connected to a combiner lens via a connecting member. The computing device may determine a current position of the combiner lens relative to a frame. The combiner lens may be at least partially transmissive to visible light, and may be configured to direct image data provided by the optical subassembly to a user's eye. Still further, the computing device may actuate an actuator configured to move the optical subassembly and connected combiner lens according to the received control inputs. The actuator may move the optical subassembly and connected combiner lens independently of the frame.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 illustrates a system for tracking a user's eye movement and moving an optical projector system and combiner lens along with the user's eye movements.

FIG. 2A illustrates an embodiment in which the combiner lens and optical projector system are moved along the x-axis.

FIG. 2B illustrates an embodiment in which the combiner lens and optical projector system are moved along the y-axis.

FIG. 3 illustrates a front perspective view of an embodiment in which the combiner lens and the projector system may be moved using actuators.

FIG. 4 illustrates a rear perspective view of an embodiment in which the combiner lens and the projector system may be moved using actuators.

FIG. 5A illustrates an embodiment of an eye-tracking system including combiner lens and connecting member.

FIG. 5B illustrates an embodiment of an eye-tracking system including combiner lens, connecting member, and actuators.

FIG. 5C illustrates an embodiment of an alternative view of an eye-tracking system including combiner lens, connecting member, and actuators.

FIG. 6 illustrates an embodiment of an actuator, including a range of motion for the actuator.

FIG. 7 illustrates a front perspective view of an embodiment of an eye-tracking system in which a movement amplifier may be implemented to amplify movement of the actuator.

FIG. 8 illustrates a top view of an embodiment of an eye-tracking system in which a movement amplifier may be implemented to amplify movement of the actuator.

FIG. 9 illustrates a front perspective view of an embodiment of an eye-tracking system in which multiple movement amplifiers may be implemented to amplify movement of multiple actuators.

FIG. 10 illustrates a front perspective view of an embodiment of an eye-tracking system in the form of augmented reality glasses.

FIG. 11 illustrates a rear perspective view of an embodiment of an eye-tracking system in the form of augmented reality glasses.

FIG. 12 illustrates a flow diagram of an exemplary method for tracking a user's eye movement and moving an optical projector system and combiner lens along with the user's eye movements.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The present disclosure is generally directed to tracking a user's eye movement and moving an optical projector system and combiner lens along with the user's eye movements. As will be explained in greater detail below, embodiments of the instant disclosure may implement various eye-tracking methodologies to track a user's eye movements. In response to those eye movements, the embodiments herein may physically move the optical projector system and combiner lens using one or more actuators. These actuators may move the connected optical projector and combiner lens in concert with the user's eye movements. Such a system may provide a more accurate representation of the image the user expects to see, even with head movements and eye movements. By providing a system that projects images in the manner expected by the user, the user may be able to constantly see the projected images regardless of which direction the user moves their eyes.

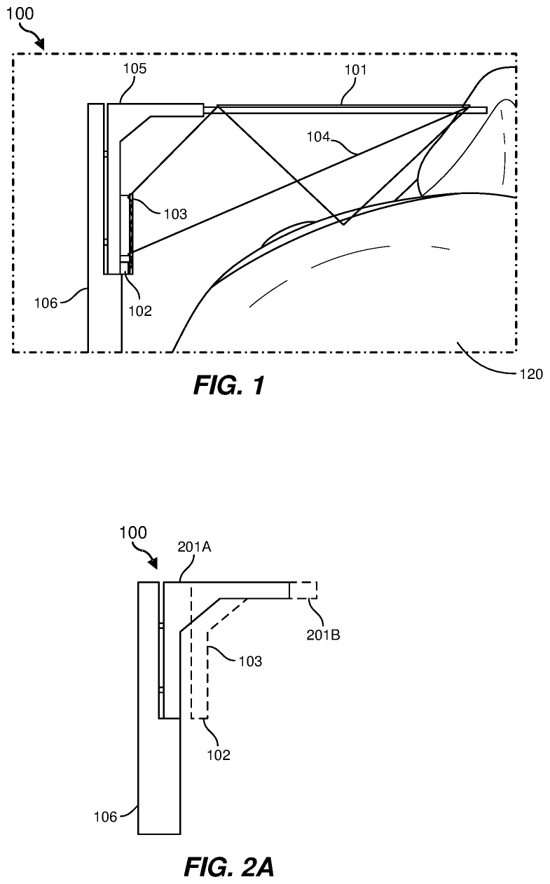

The following will provide, with reference to FIGS. 1-12, detailed descriptions of systems and methods for moving a combiner lens and connected optical projector in response to user eye movements. FIG. 1, for example, illustrates an eye-tracking system 100 that may have a combiner lens 101, a waveguide 102, an optical subassembly 103, and a connecting member 105. The top-down view of FIG. 1 illustrates how light waves 104 from a laser are guided into a user's eye (e.g., user 120). While the embodiments herein generally refer to a system that provides images for two eyes, it will be understood that the system may work in the same manner for a single eye. The system may have a frame 106 onto which various components are mounted, including the connecting member 105. These components work in tandem to provide a steady image to the user.

In one embodiment, the waveguide 102 and optical subassembly 103 may generate images that are to be projected to a user 120. At least in some embodiments, the optical subassembly may have a light source such as a laser, and a spatial light modulator such as a liquid crystal on silicon (LCOS) modulator. The light waves 104 generated by the light source are projected toward the combiner lens 101, and are reflected or diffracted to the user's eye. The combiner lens 101, as generally described herein, may refer to any type of partially transmissive lens that allows surrounding light to come through, while also reflecting or diffracting light from the light source in the optical subassembly 103. The combiner lens 101 may thus provide an augmented or mixed reality environment for the user in which the user sees their outside world as they normally would through a pair of fully transparent glasses, but also sees images projected by the optical subassembly. Objects in these images may be fixed in space (i.e. tied to a certain location), or may move with the user as the user moves their head, or moves their body to a new location.

As the user moves, or changes head positions, or simply moves their eyes, the user may expect to see different images, or may expect the images to shift in a certain manner. The embodiments herein allow for the user to make such movements, while mechanically compensating for these movements to provide a clear and optically pleasing image to the user. The optical subassembly 103 may be mounted to a connecting member 105, which is itself connected to the combiner lens. The combiner lens 101 may be positioned next to or mounted within the frame 106, but may have full range of movement relative to the frame. Thus, if the connecting member 105 moves, the combiner lens 101 and the optical subassembly 103 move in tandem with the connecting member. By making small adjustments to the image source and the combiner lens, the systems herein can compensate for the user's eye movements, head movements, bodily movements (including walking or running), or other types of movement. These compensatory movements of both the light projector and the combiner lens not only ensure that the user continues to see the projected images but may also reduce the negative effects often experienced by users when a projected AR or VR image does not align with what the user's brain expects. The systems described herein may actively move with the user, and may thus provide a more desirable user experience.

In one embodiment, a system may be provided for tracking a user's eye movements and moving an optical projector system and combiner lens along with the user's eye movements. For example, in FIG. 1, the system 100 may include the following: a frame 106, an optical subassembly 103 attached to the frame that provides image data to a user's eye (e.g., user 120), and a combiner lens 101 connected to the optical subassembly via a connecting member 105. The combiner lens 101 may be at least partially transmissive to visible light, and may be configured to direct image data (e.g., light waves 104) provided by the optical subassembly 103 to the user's eye. The system 100 may also include at least one actuator (e.g., 107A in FIG. 3) that moves the optical subassembly 103 and connected combiner lens 101 according to a control input. The actuator may move the optical subassembly and connected combiner lens independently of the frame 106.

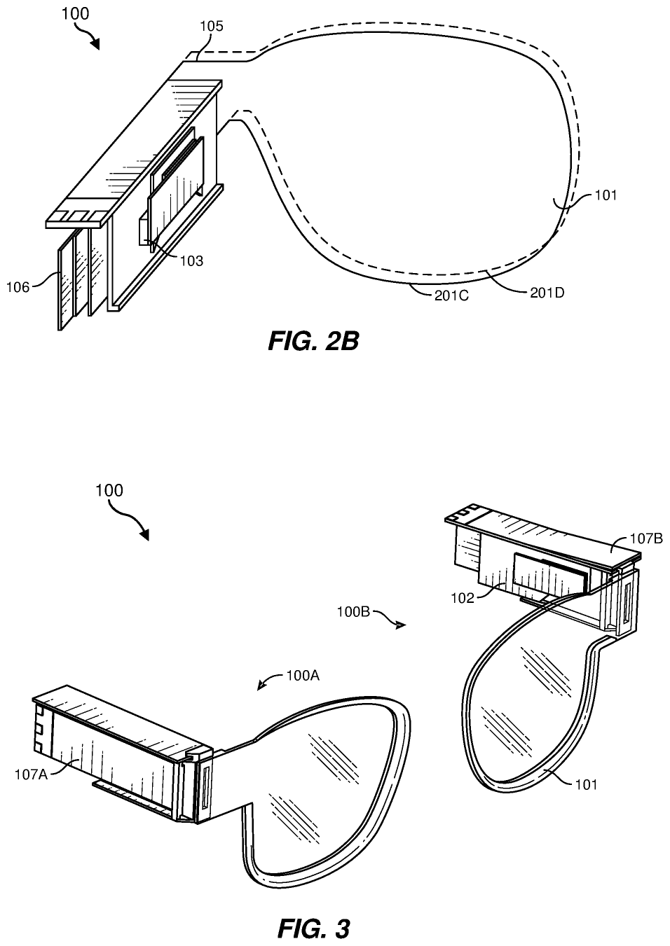

As shown in FIG. 2A, the optical subassembly 103 and connected combiner lens 101 may be moved along the x-axis relative to the frame 106. For example, in position 201B, the optical subassembly 103 and connected combiner lens 101 are moved from an initial starting position 201A to a position to the right of the starting position. In like manner, the optical subassembly 103 and connected combiner lens 101 may be moved from the initial starting position 201A to a position to the left of the starting position. In this manner, actuators (e.g., 107A of FIG. 3) may move the optical subassembly 103 and connected combiner lens 101 from one position to another along the x-axis relative to the frame 106. As will be explained further below, the actuators may cause the optical subassembly 103 and connected combiner lens 101 to move based on a control input. The control input instructs the actuator to move a specified amount in a certain direction.

As noted above, the actuators may be piezoelectric benders, walking piezoelectric actuators, piezoelectric inertia actuators, mechanically-amplified piezo block actuators, voice coil actuators, DC motors, brushless DC motors, stepper motors, microfluidic actuators, resonance-based actuators, or other types of actuators. While many of the embodiments herein are described as using a piezoelectric bimorph actuator, it will be understood that substantially any of the above-listed or other types of actuators may be used in addition to or in place of a piezoelectric bimorph. For example, voice coil actuators including linear and/or rotary voice coil actuators may be used to provide discrete and controlled movements in a given direction.

Additionally or alternatively, resonance-based actuators may be used to move the optical subassembly 103 and connected combiner lens 101. However, instead of moving the optical subassembly 103 and connected combiner lens 101 in discrete steps in response to eye tracking data, two diffractive optical combiner elements may be scanned in orthogonal axis to the other at specified frequencies. In some embodiments, these scans may occur without regard for eye position, as the scanning elements (e.g., 101 and 103) may create a larger working eye box, allowing the user to see the projected image in a greater number of locations. Accordingly, resonance may be used as the means of establishing a consistent motion profile, having consistent speed and amplitude. In some cases, a resonance-based actuator may include a beam element holding a diffractive combiner. This diffractive combiner may then be resonantly stimulated by a piezo stack actuator.

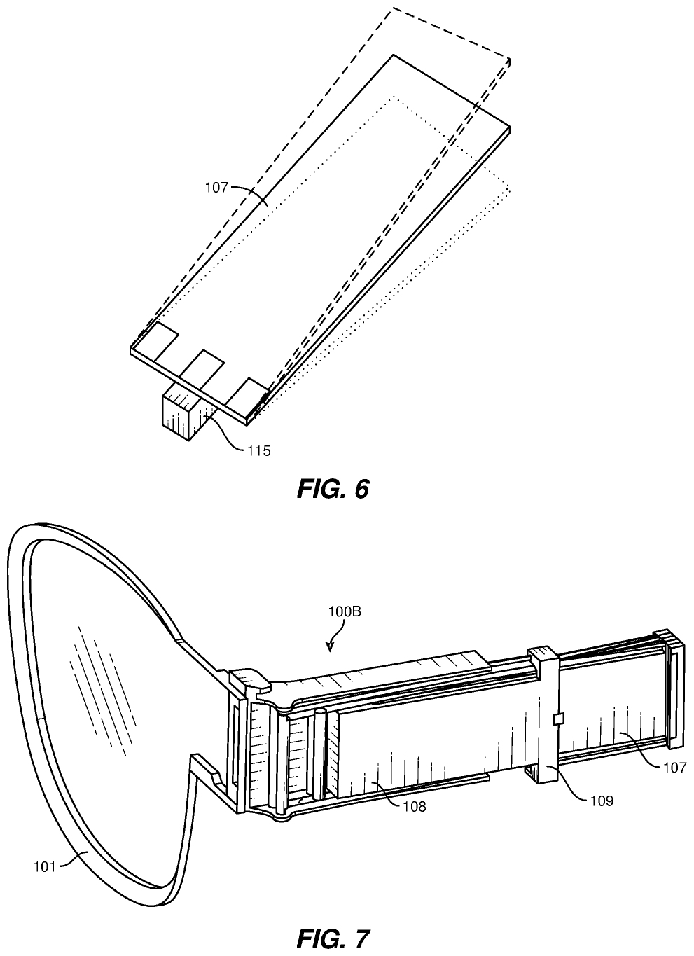

In response to an electrical stimulus signal, the actuators (e.g., piezoelectric benders) may move from a stationary position to a slightly bent position. The amount of bend may be configurable, and may be specified by the control signal. When the piezoelectric bender contracts, it forms a bend in its structure. As will be explained further below with regard to FIG. 6, the piezoelectric bender may bend upward or downward, relative to a fixed end. Thus, if the proximal end of the bender is fixed in place, the distal end may bend upward or downward. The amount of movement may vary based on the type of actuator used, but at least some of the movements may be between 0-3 mm in either direction.

Furthermore, as shown in FIG. 2B, the optical subassembly 103 and connected combiner lens 101 may be moved by actuators along the y-axis relative to the frame 106. For instance, the combiner lens 101 and connected optical assembly 103 may move from an initial position 201C to a secondary position 201D that is above the initial position. In similar fashion, the actuator may move the combiner lens 101 and connected optical assembly 103 to a position that is below the initial position 201C along the y-axis. Accordingly, if the frame 106 is stationary, the optical subassembly 103 and connected combiner lens 101 will move upward or downward relative to the frame.

Movement along the y-axis may be supplemented by movement along the x-axis. As such, actuators may move the optical subassembly 103 and connected combiner lens 101 along both the x- and y-axes at the same time, resulting in quadrilateral movement. Accordingly, bilateral movements along the x-axis or y-axis may be applied individually, or may be applied simultaneously in quadrilateral movements (e.g., upward and to the right, or downward and to the left, etc.). Some actuators may be able to move the optical subassembly 103 and connected combiner lens 101 in one direction (e.g., only to the left (not right) or only upward (not downward), while other actuators may be able to move the optical subassembly 103 and connected combiner lens 101 in two directions (e.g., right and left, or upward and downward). Different combinations of actuators may be used within the system 100 to move the optical subassembly 103 and connected combiner lens 101 as needed in a given implementation.

As noted above, the optical subassembly 103 of the system 100 may include a variety of different electronic components that provide light and/or images to a user's eyes (via light waves 104). In some embodiments, the electronic components that make up the optical subassembly 103 may include a laser, a waveguide, and a spatial light modulator (e.g., an LCOS waveguide 102). The optical subassembly 103 may also include electronic components that are configured to track movement of the user's eye. Many different techniques and technologies may be used to track the user's eye movements and/or head movements. Regardless of which eye-tracking technologies or hardware are used, these eye-tracking electronic components may provide the control input used by the system. The control input indicates that the users' eye has moved upward and to the left, for example. The control input may also indicate how far the user's eye has moved in that direction. Using this control input, the system 100 may either control the actuators directly based on the control input, or may interpret the control input and determine the best way to move the optical subassembly 103 and connected combiner lens 101 in response to the control input. These control inputs and movement determinations may be made on a continual or continuous basis as the user is using the system 100. Thus, as the user moves their eyes, the system 100 will respond with movements to follow the user's eyes. The system movements may be so quick and/or small that they are nearly imperceptible. The effect on the wearer, however, may be substantial.

In at least some embodiments, the combiner lens 101 may be rigidly connected to the optical subassembly 103 via the connecting member 105. The connecting member 105 may be made of plastic, metal, glass, porcelain, wood, carbon fiber or other material or combination of materials. The connecting member 105 may be connected to the frame 106 in a way that allows movement along the x-axis and/or along the y-axis relative to the frame. In this manner, the frame can provide a structural support for the connecting member 105, and the optical subassembly 103 and connected combiner lens 101 can be free to move (at least some distance) relative to the frame. In some cases, the connecting member 105 may include a housing for the optical subassembly 103. The housing may extend around the electronic components of the optical subassembly 103, and/or around other system components including the connecting member 105.

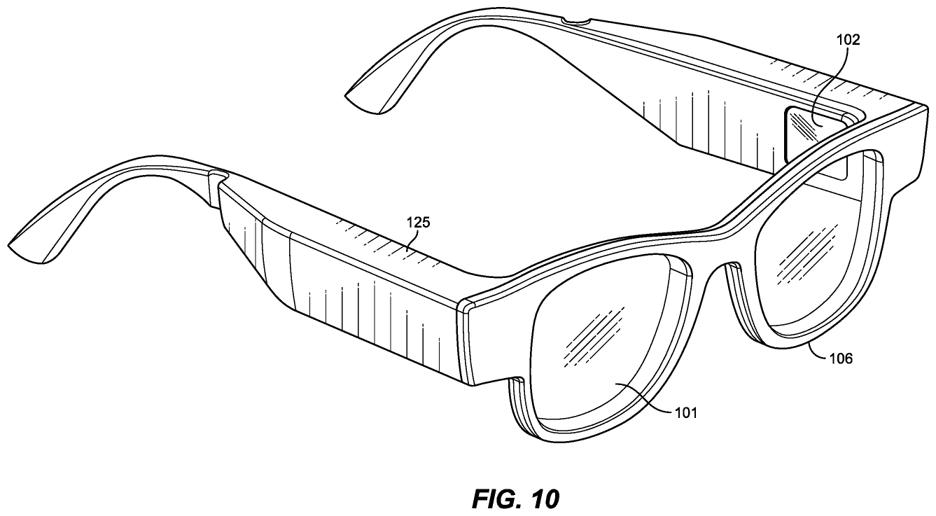

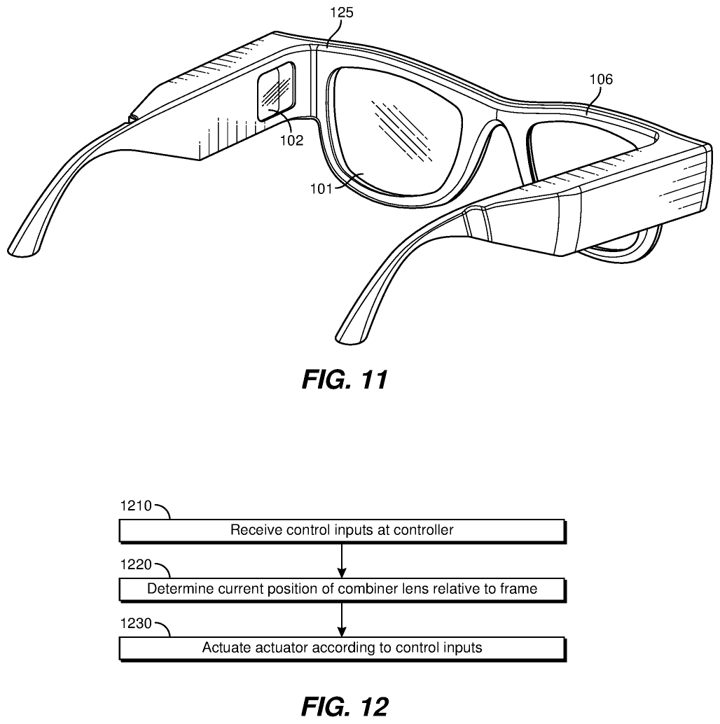

As shown in FIG. 3, at least in some embodiments, the system 100 may include two subparts (100A and 100B), each having its own optical subassembly and combiner lens, thereby providing one subpart for each eye. For example, the system 100 may be designed as a pair of glasses (as illustrated further in FIGS. 10 and 11). In such cases, each combiner lens 101 and connected optical subassembly 103 may be actuated independently. As such, the actuators of the right eye may act independently of the actuators of the left eye. In other cases, a single control signal controls the actuators on both sides. Similarly, eye-tracking hardware and software components may be configured to separately track each user eye. Thus, the input control signals may be based on movements from a single eye or from both eyes. Accordingly, in at least one embodiment, each side of the glasses may have its own independent eye-tracking hardware and/or software components, and each side of the glasses has its own actuators and controllers to move the optical subassembly 103 and connected combiner lens 101. It will be understood that other hardware components such as microprocessors and memory may be provided on each side of the glasses, or may be shared by both sides. The microprocessors and memory, and perhaps even data storage, may be used to process eye-tracking sensor measurements, generate control signals for the actuators, and/or store past control signal responses to the user's movements.

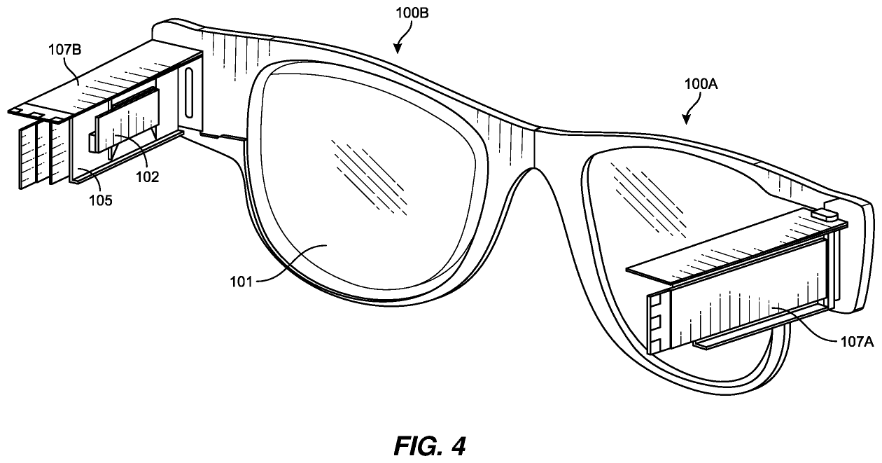

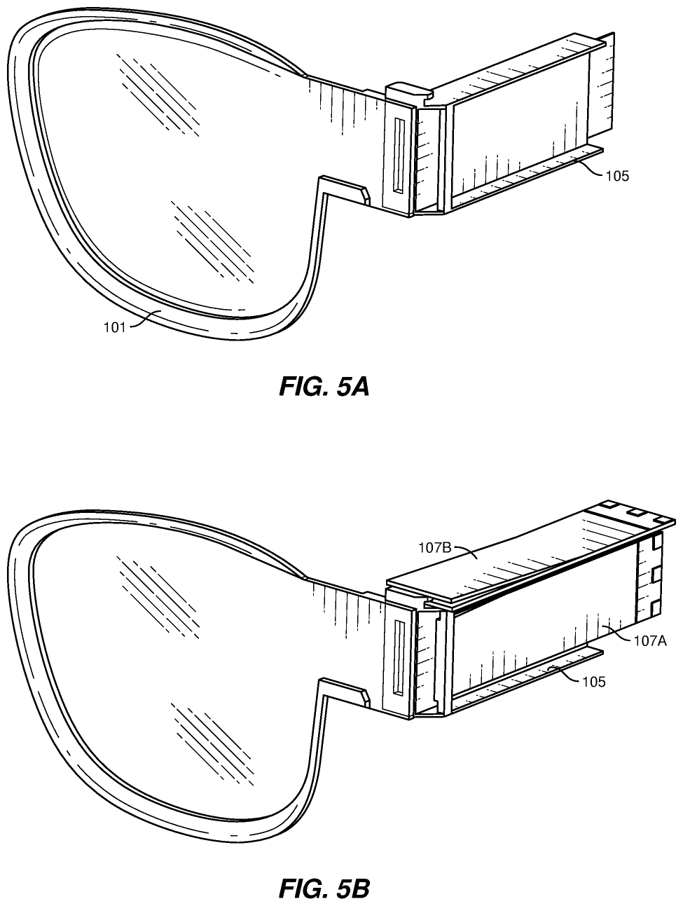

FIG. 3 further illustrates two different actuators placed in two different positions on the system. For example, actuator 107A may be placed on the outside of system subpart 100A, while actuator 107B is placed on the top of subpart 100B. The actuator 107A may be configured to move the subpart 100A to the right and/or to the left along the x-axis, and the actuator 107B may be configured to move the subpart 100B up and/or down along the y-axis, relative to the frame. FIG. 4 illustrates the actuators 107A and 107B on system subparts 100A and 100B, respectively, but from a rear perspective view. Although the optical subassembly 103 can only be seen on the left side of the glasses (i.e., in subpart 100B), it will be understood that the right side of the glasses (i.e., subpart 100A) may also have its own optical subassembly and/or its own eye-tracking hardware and/or embedded software or processors.

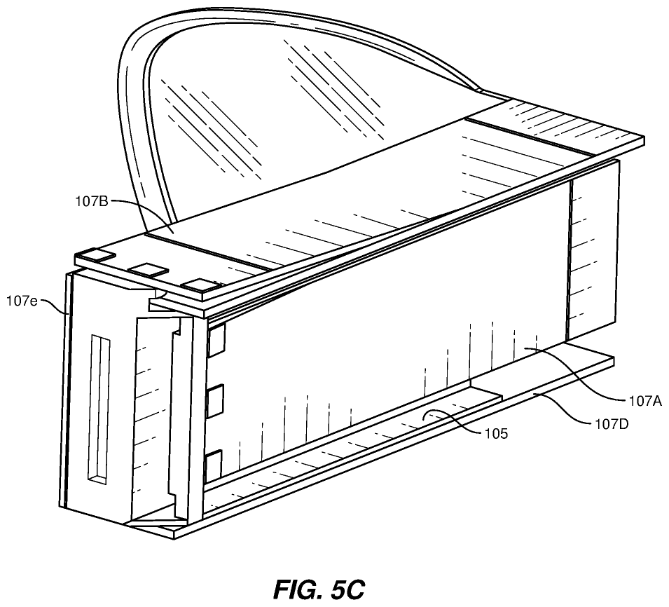

In FIGS. 5A & 5B, each arm of the frame may include multiple actuators that move the optical subassembly and connected combiner lens. In FIG. 5A, one embodiment of the connecting member 105 is shown without any actuators, while in FIG. 5B, the connecting member 105 is shown with two actuators: 107A and 107B. In such cases, actuator 107B may move the optical subassembly and connected combiner lens in the y direction, and actuator 107A may move the optical subassembly and connected combiner lens in the x direction. In FIG. 5C, the connecting member 105 is shown with four actuators: 107A, 107B, 107C and 107D. In such cases, two of the actuators (107B and 107D) may move the optical subassembly and connected combiner lens in the y direction, and two of the actuators (107A and 107C) may move the optical subassembly and connected combiner lens in the x direction relative to the frame. Thus, regardless of the number of actuators used, the optical subassembly and connected combiner lens may be moved to compensate for the user's eye or head movements.

As shown in FIG. 6, the actuators (which may be collectively referred to as 107) may be configured to move relative to a fixed base 115. In some cases, the actuator 107 may only move up, or may only move down relative to the fixed base 115. In other cases, the actuator may be configured to move in either direction, depending on which type of electrical actuation signal is received. Those actuators that can move in either direction may be referred to herein as “bimorph actuators.” Bimorph actuators may move the optical subassembly and connected combiner lens either left or right along the x-axis, or up or down along the y-axis relative to the frame. In cases where bimorph actuators are used, one of the bimorph actuators may move the optical subassembly and connected combiner lens in the y direction, and one of the bimorph actuators may move the optical subassembly and connected combiner lens in the x direction (e.g. in the system shown in FIG. 5B). Still further, whether a bimorph actuator is used or not, the amount of actuation (i.e. the amount of movement) may be specified by or indicated in the actuation signal fed to the actuator. Thus, a controller that provides actuation signals to the actuators 107 may control which types of movements are performed, and the relative strength or distance of those movements.

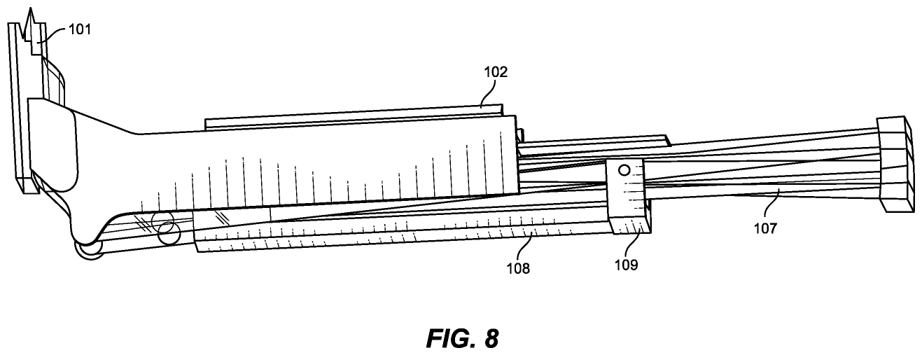

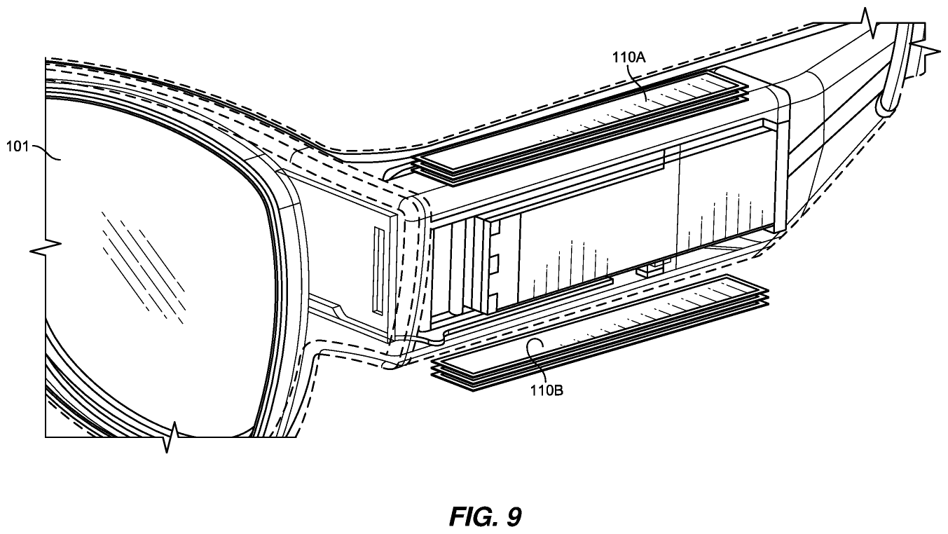

In some examples, as generally shown in FIG. 7, movement of the actuators 107 may be magnified or accentuated using a substructure 108 that provides a pivot point 109. This substructure 108 may be configured to fit multiple actuators 107, and may allow each movement of the actuators to be magnified into a movement of greater length. Thus, for example, if a movement of 2 mm is needed, and a single actuator is only capable of 1 mm of movement, then the substructure 108 may be implemented to amplify the actuator's movements and allow them to extend to a greater length. Accordingly, as shown in FIG. 8, the actuator(s) 107 may pivot on the pivot point 109, and provide translational movement to the distal end of the actuators. Because the actuator(s) 107 and substructure 108 are attached to the connecting member 105, the combiner lens 101 and the connected optical subassembly 103 (not shown in FIG. 8) may be moved with the movements of the actuator(s). Accordingly, such a structure may amplify movements produced by the actuators.

In some embodiments, as generally shown in FIG. 9, a plurality of actuators may be stacked as groups of actuators 110A or 110B. Such actuators may work in tandem to move the combiner lens 101 and optical subassembly. In some embodiments, the combination of actuators may allow for an increase in output force and may compensate for reduction of output force resulting from displacement amplification mechanisms. Each actuator may be run using the same control signal and, as such, each group of actuators 110A or 110B may act as a single unit to provide translational motion to a connected combiner lens and optical subassembly. The groups of actuators may be used on a single side of the eye-tracking system's connecting member 105, on two sides (as shown in FIG. 9), or on four sides. Thus, for example, embodiments may be provided where one or more sides has a single actuator, while one or more other sides have groups of actuators to provide the movement.

Piezoelectric flexure amplifiers may be implemented, at least in some embodiments, to amplify movement of the optical subassembly 103 relative to the connected combiner lens 101. In some embodiments, the piezoelectric flexure amplifiers may be used to amplify movement of the optical subassembly 103 and the connected combiner lens 101 by increasing the effective displacement of the actuators (e.g., 110A or 110B).

FIGS. 10 and 11 illustrate front and rear perspective views of a pair of augmented reality (AR) glasses 125. Although AR glasses are shown in FIGS. 10 and 11, it will be understood that virtual reality (VR) or mixed reality glasses or other eyewear may also be used. The AR glasses 125 include a frame 106, combiner lenses 101, and a visible waveguide 102. The optical subassembly may lie behind or near the waveguide 102 but is not visible in these drawings. Each arm of the glasses (e.g., 100A or 100B) may include a covering or housing that goes around the internal components including the connecting member 105, actuators 107, optical subassembly 103, and/or other components including a battery, processor, data store (e.g. a flash memory card), eye-tracking hardware and/or software, or other components.

The AR glasses 125 may also include a wireless communication means such as a WiFi radio, cellular radio, Bluetooth radio, or similar communication device. The AR glasses 125 may thus receive video signals from an external source which are to be projected to the user's eyes. While the user is viewing the projected images on the combiner lenses 101, the user's eyes and/or head may move, perhaps in reaction to the content being displayed on the combiner lenses. As the user moves their eyes and/or head, the integrated eye-tracking system may track the user's eyes and move the connected optical subassembly 103 and combiner lenses 101 in tandem with the user's eye movements. This may provide for a smoother, more immersive experience for the user.

FIG. 12 illustrates a flow diagram of an exemplary computer-implemented method 100 for tracking a user's eye movement and moving an optical projector system and combiner lens along with the user's eye movements. The steps shown in FIG. 12 may be performed by any suitable computer-executable code and/or computing system, including the system(s) illustrated in FIGS. 1-11. In one example, each of the steps shown in FIG. 12 may represent an algorithm whose structure includes and/or is represented by multiple sub-steps, examples of which will be provided in greater detail below.

As illustrated in FIG. 12, at step 1210, one or more of the systems described herein may track a user's eye movement and moving an optical projector system and combiner lens along with the user's eye movements. For example, the method may include receiving control inputs at a controller. The controller may be part of an optical subassembly 103 that is connected to a combiner lens 101 via a connecting member 105. The method may also include determining a current position of the combiner lens relative to a frame (step 1220). The combiner lens 101 may be at least partially transmissive to visible light and may be configured to direct image data provided by the optical subassembly to a user's eye, as generally shown in FIG. 1. The method may further include actuating an actuator 107 that may move the optical subassembly 103 and connected combiner lens 101 according to the received control inputs (step 230). The actuator 107 may move the optical subassembly 103 and connected combiner lens 101 independently of the frame 106.

In some embodiments, the control inputs may be generated based on tracked eye movements of the user's eye. Thus, in such embodiments, eye-tracking hardware and/or software may be used to follow a user's pupil or other portions of the user's eye. As the user's eye moves, direction and speed data representing the user's eye movements may be sent to a controller or processor. The controller or processor may interpret the direction and speed data and, based on that data, may generate control inputs for the eye-tracking system 100. These control inputs may be sent to the actuators to cause actuation in a given pattern. The actuation moves the connected optical subassembly 103 and combiner lens 101 in line with the user's eye movements. In some embodiments, the frame 106 may include a slot for the combiner lens to slide through as the combiner lens and connected optical subassembly are moved by the actuator. The combiner lens 101 may be designed to slide substantially next to the frame 106 without touching the frame. As such, the combiner lens and connected optical subassembly may move in the x and y directions relative to the plane of the frame, while the frame itself remains substantially stationary. In cases where the lens touches the frame, friction reduction methods may be implemented to reduce the friction. This may include using different materials at the touching points to reduce the coefficient of friction between the frame and combiner lenses, as well as using flexure suspension (beam, wire, etc.), elastomeric suspension (sheet, membrane, cord, etc.), ball bearings, fluid-filled membrane suspension, or other means of reducing friction between the frame and combiner lens.

In some embodiments, displacement sensors (e.g., linear strip encoders) may be affixed to the connecting member 105. These linear strip encoders may be implemented to determine movement of the optical subassembly and connected combiner lens. The linear strip encoders may track where the optical subassembly and connected combiner lens are in an initial position, and then subsequently track motion of the optical subassembly and/or connected combiner lens. The movement data may then be fed to a processor or controller as feedback. This feedback data may be used to further optimize the control inputs sent to the actuators. Such a feedback loop may increase the accuracy of the movements provided by the actuators, and may make the overall user experience even more desirable.

In some examples, the above-described method may be encoded as computer-readable instructions on a computer-readable medium. For example, a computer-readable medium may include one or more computer-executable instructions that, when executed by at least one processor of a computing device, may cause the computing device to track a user's eye movement and move an optical projector system and combiner lens along with the user's eye movements. The computing device may receive control inputs at a controller. The controller may be part of an optical subassembly that is connected to a combiner lens via a connecting member. The computing device may determine a current position of the combiner lens relative to a frame. The combiner lens may be at least partially transmissive to visible light, and may be configured to direct image data provided by the optical subassembly to a user's eye. Still further, the computing device may actuate an actuator configured to move the optical subassembly and connected combiner lens according to the received control inputs. The actuator may move the optical subassembly and connected combiner lens independently of the frame.

It should further be noted that although the embodiments herein have been chiefly described in conjunction with AR/VR glasses, the embodiments that move an optical subassembly and connected combiner lens may be used in a variety of different scenarios and embodiments. For example, the actuators described herein may be used to move a laser projector or series of laser projectors in conjunction with a projection screen or other display. Control inputs may similarly be received from an eye-tracking or head-tracking system, and may be used to control small movements in the laser projector(s) and/or projection screen. Indeed, the embodiments described herein may function with substantially any type of image projection or display system that is capable of movement in relation to a user's movements.

Moreover, while a waveguide and LCOS have been described above in at least some of the embodiments, it will be understood that substantially any type of display subassembly or optical engine may be used. Such an optical engine may be connected to the connecting member 105 which rigidly connects to the combiner lens. The combiner lens may be partially transmissive to visible light so that the user can see the outside world, but the combiner lenses also reflect or refract the image that has gone through the waveguide, then off the LCOS back to the user's eye. Such an embodiment may have a wide field of view, but the entrance to the user's pupil may still be quite narrow. As such, if the user looks off, the focus may be blurry or no image may be seen at all. Using the embodiments herein, the optical engine and combiner lenses may be actively moved to shift around the position of the entrance pupil to match where the eye is looking. In this manner, the image provided by the optical engine and reflected off the combiner lenses will be sent into the moving eye box associated with the user.

### EXAMPLE EMBODIMENTS

### Example 1

A system comprising a frame, a connecting member, an optical subassembly attached to the frame configured to provide image data to a user's eye, at least one combiner lens connected to the optical subassembly via the connecting member, wherein the combiner lens is at least partially transmissive to visible light, and is configured to direct image data provided by the optical subassembly to the user's eye, and at least one actuator configured to move the optical subassembly and connected combiner lens according to a control input, wherein the actuator moves the optical subassembly and connected combiner lens independently of the frame.

### Example 2

The system of Example 1, wherein the at least one actuator comprises a piezoelectric bimorph.

### Example 3

The system of any of Examples 1-2, wherein the optical subassembly comprises: at least one laser, at least one waveguide, at least one spatial light modulator, and a combiner.

### Example 4

The system of any of Examples 1-3, wherein the connecting member includes a housing for the optical subassembly.

### Example 5

The system of any of Examples 1-4, wherein the optical subassembly includes one or more electronic components configured to track movement of the user's eye.

### Example 6

The system of any of Examples 1-5, wherein the eye tracking electronic components provide the control input, such that the actuator moves the optical subassembly based on the user's eye movements.

### Example 7

The system of any of Examples 1-6, wherein the system includes two optical subassemblies and two combiner lenses, and wherein each combiner lens and connected optical subassembly is actuated independently.

### Example 8

The system of any of Examples 1-7, wherein each combiner lens and connected optical subassembly tracks a separate user eye.

### Example 9

The system of any of Examples 1-8, wherein the frame includes two arms, and wherein each arm includes a plurality of actuators that move the optical subassembly and connected combiner lens, at least one of the actuators moving the optical subassembly and connected combiner lens in the y direction, and at least one of the actuators moving the optical subassembly and connected combiner lens in the x direction.

### Example 10

The system of any of Examples 1-9, wherein the frame includes two arms, and wherein each arm includes two bimorph actuators that move the optical subassembly and connected combiner lens, one of the bimorph actuators moving the optical subassembly and connected combiner lens in the y direction, and one of the bimorph actuators moving the optical subassembly and connected combiner lens in the x direction.

### Example 11

A computer-implemented method comprising: receiving one or more control inputs at a controller, the controller being part of an optical subassembly that is connected to a combiner lens via a connecting member, determining a current position of the combiner lens relative to a frame, wherein the combiner lens is at least partially transmissive to visible light, and is configured to direct image data provided by the optical subassembly to a user's eye, and actuating at least one actuator configured to move the optical subassembly and connected combiner lens according to the received control inputs, wherein the actuator moves the optical subassembly and connected combiner lens independently of the frame.

### Example 12

The computer-implemented method of Example 11, wherein the control inputs are generated based on tracked eye movements of the user's eye.

### Example 13

The computer-implemented method of any of Examples 11-12, wherein the frame includes at least one slot for the combiner lens to slide through as the combiner lens and connected optical subassembly are moved by the actuator.

### Example 14

The computer-implemented method of any of Examples 11-13, wherein the combiner lens is designed to slide substantially within the frame.

### Example 15

The computer implemented method of any of Examples 11-14, wherein one or more piezoelectric flexure amplifiers are implemented to amplify movement of the optical subassembly and connected combiner lens.

### Example 16

The computer-implemented method of any of Examples 11-15, wherein the piezoelectric flexure amplifiers are configured to amplify movement of the optical subassembly and connected combiner lens by increasing the effective displacement of the at least one actuator.

### Example 17

The computer-implemented method of any of Examples 11-16, wherein one or more displacement sensors are affixed to the connecting member and are implemented to determine movement of the optical subassembly and connected combiner lens.

### Example 18

The computer-implemented method of any of Examples 11-17, wherein the optical subassembly includes a liquid crystal on silicon spatial light modulator.

### Example 19

The computer-implemented method of any of Examples 11-18, wherein the at least one actuator comprises a voice coil actuator.

### Example 20

A non-transitory computer-readable medium comprising one or more computer-executable instructions that, when executed by at least one processor of a computing device, cause the computing device to: receive one or more control inputs at a controller, the controller being part of an optical subassembly that is connected to a combiner lens via a connecting member, determine a current position of the combiner lens relative to a frame, wherein the combiner lens is at least partially transmissive to visible light, and is configured to direct image data provided by the optical subassembly to a user's eye, and actuate at least one actuator configured to move the optical subassembly and connected combiner lens according to the received control inputs, wherein the actuator moves the optical subassembly and connected combiner lens independently of the frame.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive data to be transformed, transform the data, output a result of the transformation to perform a function, use the result of the transformation to perform a function, and store the result of the transformation to perform a function. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

Embodiments of the instant disclosure may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

I claim:

1. A system comprising:
a frame;
a connecting member;
an optical subassembly attached to the frame configured to provide image data to a user's eye;
at least one combiner lens connected to the optical subassembly via the connecting member, wherein the combiner lens is at least partially transmissive to visible light, and is configured to direct image data provided by the optical subassembly to the user's eye; and
at least one actuator configured to move the optical subassembly and connected combiner lens according to a control input, wherein the actuator moves the optical subassembly and connected combiner lens independently of the frame.

2. The system of claim 1, wherein the at least one actuator comprises a piezoelectric bimorph.

3. The system of claim 1, wherein the optical subassembly comprises:
at least one laser;
at least one waveguide;
at least one spatial light modulator; and
a combiner.

4. The system of claim 1, wherein the connecting member includes a housing for the optical subassembly.

5. The system of claim 1, wherein the optical subassembly includes one or more electronic components configured to track movement of the user's eye.

6. The system of claim 5, wherein the eye tracking electronic components provide the control input, such that the actuator moves the optical subassembly based on the user's eye movements.

7. The system of claim 1, wherein the system includes two optical subassemblies and two combiner lenses, and wherein each combiner lens and connected optical subassembly is actuated independently.

8. The system of claim 7, wherein each combiner lens and connected optical subassembly tracks a separate user eye.

9. The system of claim 1, wherein the frame includes two arms, and wherein each arm includes a plurality of actuators that move the optical subassembly and connected combiner lens, at least one of the actuators moving the optical subassembly and connected combiner lens in the y direction, and at least one of the actuators moving the optical subassembly and connected combiner lens in the x direction.

10. The system of claim 1, wherein the frame includes two arms, and wherein each arm includes two bimorph actuators that move the optical subassembly and connected combiner lens, one of the bimorph actuators moving the optical subassembly and connected combiner lens in the y direction, and one of the bimorph actuators moving the optical subassembly and connected combiner lens in the x direction.

11. A computer-implemented method comprising:
receiving one or more control inputs at a controller, the controller being part of an optical subassembly that is connected to a combiner lens via a connecting member;
determining a current position of the combiner lens relative to a frame, wherein the combiner lens is at least partially transmissive to visible light, and is configured to direct image data provided by the optical subassembly to a user's eye; and
actuating at least one actuator configured to move the optical subassembly and connected combiner lens according to the received control inputs, wherein the actuator moves the optical subassembly and connected combiner lens independently of the frame.

12. The computer-implemented method of claim 11, wherein the control inputs are generated based on tracked eye movements of the user's eye.

13. The computer-implemented method of claim 11, wherein the frame includes at least one slot for the combiner lens to slide through as the combiner lens and connected optical subassembly are moved by the actuator.

14. The computer-implemented method of claim 11, wherein the combiner lens is designed to slide substantially within the frame.

15. The computer implemented method of claim 11, wherein one or more piezoelectric flexure amplifiers are implemented to amplify movement of the optical subassembly and connected combiner lens.

16. The computer-implemented method of claim 15, wherein the piezoelectric flexure amplifiers are configured to amplify movement of the optical subassembly and connected combiner lens by increasing the effective displacement of the at least one actuator.

17. The computer-implemented method of claim 11, wherein one or more displacement sensors are affixed to the connecting member and are implemented to determine movement of the optical subassembly and connected combiner lens.

18. The computer-implemented method of claim 11, wherein the optical subassembly includes a liquid crystal on silicon spatial light modulator.

19. The computer-implemented method of claim 11, wherein the at least one actuator comprises a voice coil actuator.

20. A non-transitory computer-readable medium comprising one or more computer-executable instructions that, when executed by at least one processor of a computing device, cause the computing device to:
receive one or more control inputs at a controller, the controller being part of an optical subassembly that is connected to a combiner lens via a connecting member;
determine a current position of the combiner lens relative to a frame, wherein the combiner lens is at least partially transmissive to visible light, and is configured to direct image data provided by the optical subassembly to a user's eye; and
actuate at least one actuator configured to move the optical subassembly and connected combiner lens according to the received control inputs, wherein the actuator moves the optical subassembly and connected combiner lens independently of the frame.
